(19) United States
(12) Patent Application Publication
(10) Pub. No.: US 2009/0100659 A1
(43) Pub. Date: Apr. 23, 2009

(54) TRAILER WHEEL LOCKING PIN RETRACTOR

(76) Inventor: Radovan Soumar, Hindsdale, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 12/237,418

(22) Filed: Sep. 25, 2008

Related U.S. Application Data
(60) Provisional application No. 60/975,352, filed on Sep. 26, 2007.

(51) Int. Cl. B23P 19/04

(52) U.S. Cl. 29/247

(57) ABSTRACT

A pin extractor includes a support tube having a base which is larger in diameter than the remainder of the tube. The base and at least a portion of the tube including cut out slot for the handle of a pin to be retracted. The support shaft includes an end cap opposite the base. The end includes a circular region having a diameter large enough to accept a support chain as well as a slot through which the support chain can be locked into position.

### CROSS-REFERENCE TO RELATED APPLICATIONS

This application claims priority to U.S. Patent Application No. 60/975,352 filed on Sep. 26, 2007 entitled “Tensioning Device for Trailer Release”, which is incorporated fully herein by reference.

### TECHNICAL FIELD

The present invention relates to an apparatus for use with semi-trailer wheel locking pins and more particularly, relates to a device for use in retracting locking pins used to lock into position movable bogie wheels on tractor-trailers.

### BACKGROUND INFORMATION

Tractor-trailers include a trailer bed supported above the roadway by a multi-wheel system. The multi-wheel system is often termed a “bogie” wheel. Oftentimes, truck drivers find it necessary to move the bogie wheels forward or backward relative to the trailer bed to properly support the load that they intend to carry. Pins are used to lock a set of bogie wheels into position relative to the trailer bed. These pins are spring-loaded and located under the trailer bed exposed to road spray, salt, dirt and other elements.

Before the bogie wheels can be moved, the pins must be released. In order to release the pins, the driver must pull the pin against the compression of the spring while at the same time trying to dislodge the pin from the bogie wheel. The pin is often forced against the bogie wheel and many times the trailer itself must be rocked back and forth to dislodge it. This takes several people or some device attached to the pin to pull on it while the driver rocks the trailer back and forth. An example of how a trailer bogie wheel release pins work can be found in U.S. Pat. No. 6,322,091 incorporated herein by reference.

Several attempts have been made to produce devices that can assist a tractor-trailer driver in releasing the pin found on the bogie wheels of a trailer. One such device is called the “Rod Jumper” axle slider tool. This tool utilizes a clamp that is attached to the trailer and through which slides the chain and a spring that connects at one end to the pin of the bogie wheels while the other is connected to a handle. In theory, the driver attaches the clamp to the trailer bed, attaches one end of the chain to the pin and grabs a handle at the other end of the chain to pull on the pin. A spring in the chain link provides some tension against the pin. The driver may set the device to some amount of tension, clamp it to the trailer rail in the hopes it will stay in place, and move the trailer back and forth in an attempt to dislodge the pin. In practice, this device does not work as the clamp easily falls off the trailer.

Another prior at device is disclosed in U.S. Pat. No. 6,322,091. This device includes a tube having a handle connected to one end of a spring while the other is attached to the handle of the release pin of the bogie wheel. A series of relatively complex mechanisms are provided to help hold the handle in place in a position that applies tension on the bogie wheel pin. The mechanism to hold the handle is complicated and very prone to breaking.

Accordingly, what is needed is a simple and inexpensive bogie wheel pin puller that is easily set by a tractor-trailer driver to provide tension against the bogie pin while an attempt to dislodge the pin is made.

### SUMMARY OF THE INVENTION

The present invention features a pin retractor, for connecting with a pin and for allowing a user to maintain nearly constant retraction tension on the pin. The pin retractor comprises a tube member having a diameter and a first end and a second end. The first end including a cap including an opening having a first cross section in a first direction through which a chain link can pass, and a second cross-section in a second direction through which a chain link cannot pass. The second end has a diameter which is larger than a diameter of the tube member and configured for being held in against a side member through which the pin to be retracted protrudes.

The tube member includes a slot extending from the second end a predetermined distance toward the first end of the tube. The invention further includes a pin engagement hook having a first end for engaging with the pin to be retracted and a second end. A tensioning spring having a first end coupled to the second end of the pin engagement hook and a second end is also provided. A length of chain link elements is provided. The length of chain link elements has a first end and a second end. The first end of the length of chain link elements is coupled to the second end of the tensioning spring while the second end is coupled to a handle.

### BRIEF DESCRIPTION OF THE DRAWINGS

These and other features and advantages of the present invention will be better understood by reading the following detailed description, taken together with the drawings wherein:

FIG. 1 is cutaway cross-sectional view of the pin retractor of the present invention;

FIG. 2 is a side view of the pin retractor support shaft according to the present invention;

FIG. 3 is an end view of the of the support shaft of the pin extractor according to the present invention; and

FIG. 4 is a side schematic view of the pin retractor of the present invention in place and coupled to a pin to be retracted.

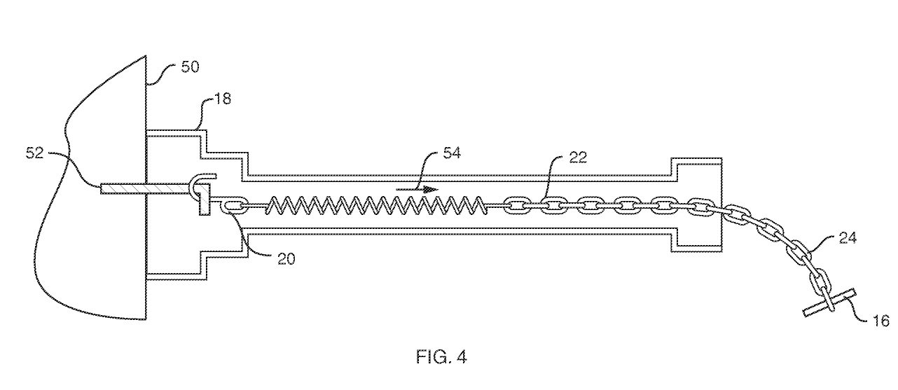

### DETAILED DESCRIPTION OF THE PREFERRED EMBODIMENTS

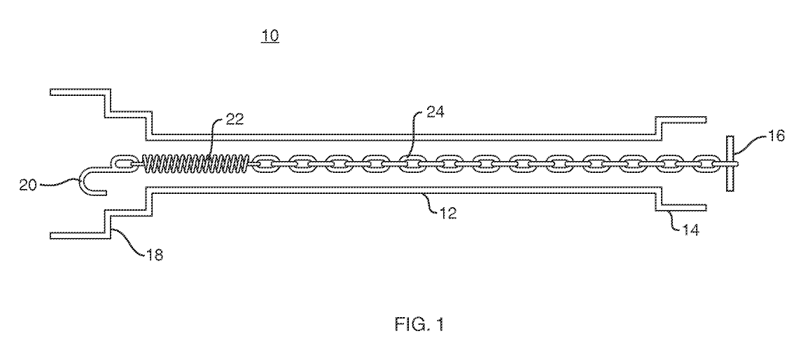

The present invention features a pin retractor 10, FIG. 1, use to retract a pin of the type used, for example, to hold tractor-trailer wheels in place yet when retracted, allowing the wheels to move forward or backward to properly balance a load on the trailer. In the preferred embodiment, pin retractor 10 is comprised of a tube member 12 having a total overall length of approximately 24 inches and between 2 to 2½ inches in diameter. In the preferred embodiment, the tube member 12 is made of a PVC plastic material although this is not a limitation of the present invention.

Tube member 12 includes a first end 14 through which handle 16 protrudes as will be explained in greater detail below. Second and 18 includes one or more stepped regions having a larger diameter which serves to stabilize the retractor 10 against the side of a trailer frame. Pin retractor 10 includes an “S” type hook 20 coupled to a tensioning spring 22 which is interned coupled to a length of chain 24. In use, as will be seen in greater detail below, the user engages hook 20 with the pin to be retracted and pulls on handle 16 which causes chain 24 to place tension on tensioning spring 22 and ultimately on the locking pin to be retracted.

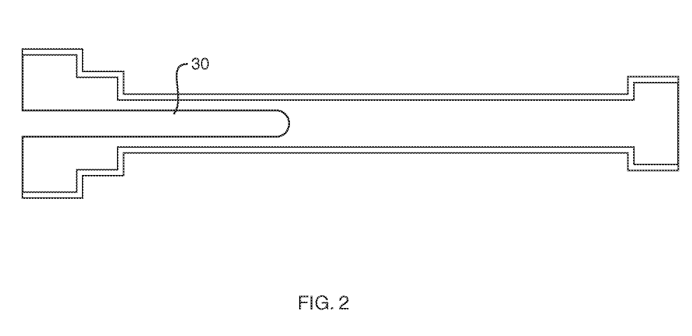

In the preferred embodiment, the tube member 12 includes a slot 30, FIG. 2, which is required if the end of the pin to be retracted is wider than the diameter of tube member 12. Slot 30 is sized to allow the end of the pin to be retracted to slide in and out of the slot 30. Slot 30 has a typical length of approximately 11 inches.

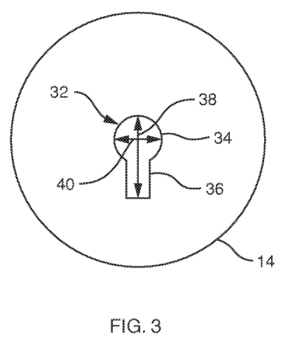

First and 14, FIG. 3, of tube member 12 includes opening 32 having, in the preferred embodiment, a circular portion 34 and an attached rectangular portion 36. The combined diameter of circular portion 34 and a length of rectangular portion 36 as shown by arrow 38 is sized such that a chain link from chain 24 can slide through opening 32 while the width of circular portion 34 as shown by arrow 40 is small enough to prevent the chain link placed across the opening 38 from sliding through the opening thus, in essence, “locking” the chain into position against first end member 14.

In use, second end 18 of tube member 12 is placed against the side rail 50 of a trailer surrounding pin 52 that is to be retracted to allow a set of wheels to be moved forward or backward. S-hook 20 is engaged with the head or handle of the pin 52 that, if too lengthy, protrudes through slot 30 of tube member 12. The user next pulls on handle 16 that is connected to chain 24 and tensioning spring 22 causing the pin 52 to be retracted or moved in the direction indicated generally by arrow 54. Once the pin has been retracted sufficiently, the user turns handle 16 which in turn turns chain links 20 for causing one of the links to become oriented sideways “across” opening 32 in a first end member 14 thus “locking” the pin retractor onto the pin in a retracted position. If the wheels will not move, the truck operator simply leaves the device connected to the pin, returns to the cab and can rock the trailer back and forth to dislodge or disengage the wheels, all the while knowing that the pin retractor 10 of the present invention will remain connected to the pin maintaining tension on the pin.

When the wheels have been moved to the appropriate or desired position, the user pulls on handle 16 and turns the chain links allowing them to return through opening 32 in the first end member 14 releasing the tension on spring 22 and 1052 thus locking the wheels and place in a new position.

Accordingly, the present invention provides a unique, simple, trouble-free and positive locking pin extractor which allows a user to place a significant amount of pin retraction tension on the pin and if need be, locked the device onto the pin while further action is taken to free the pin and/or its adjacent item.

Modifications and substitutions by one of ordinary skill in the art are considered to be within the scope of the present invention, which is not to be limited except by the following claims.

The invention claimed is:

1. A pin retractor, for connecting with a pin and allowing a user to maintain nearly constant retraction tension on the pin, the pin retractor comprising:
a tube member having a diameter and a first end and a second end, said first end covered by a cap that includes an opening having a first cross section in a first direction through which a chain link can pass, and a second cross-section in a second direction through which a chain link cannot pass, said second end having a diameter which is larger than a diameter of said tube member and configured for being held in against a side member through which said pin to be retracted protrudes;
said tube member including a slot extending from said second end a predetermined distance toward said first end;
a pin engagement hook having a first end for engaging with said pin to be retracted and a second end;
a tensioning spring having a first end coupled to said second end of said pin engagement hook and a second end; and
a length of chain link elements, said length of chain link elements having a first end and a second end, said first end of said length of chain link elements coupled to said second end of said tensioning spring, said second end coupled to a handle.
